(19) United States
(12) Patent Application Publication
(10) Pub. No.: US 2023/0227676 A1
(43) Pub. Date: Jul. 20, 2023

(54) Method For Producing Printed Material And Wrapping Method With Wrapping Material

(71) Applicant: SEIKO EPSON CORPORATION, Tokyo (JP)

(72) Inventors: Chigusa SATO, Matsumoto (JP); Emi TAKEUCHI, Shiojiri (JP); Toru SAITO, Yamagata (JP)

(21) Appl. No.: 18/097,525

(22) Filed: Jan. 17, 2023

(30) Foreign Application Priority Data
Jan. 18, 2022 (JP) 2022-005600

(51) Int. Cl. C09D 11/101; C09D 11/106; C09D 11/30; B41J 11/00; B29C 63/40; B29C 63/00

(52) U.S. Cl. CPC C09D 11/101; C09D 11/106; C09D 11/30; B41J 11/00214; B29C 63/40; B29C 63/0065; B29C 63/0004; B29L 2031/712

(57) ABSTRACT

A method for producing a printed material includes an application step of applying a radiation-curable ink composition onto a shrink film, and a curing step of irradiating the radiation-curable ink composition on the shrink film with radiation to form a cured ink coating, thus obtaining a printed material. The radiation-curable ink composition contains one or more polymerizable compounds whose weighted average glass transition temperature is 20° C. to 70° C.

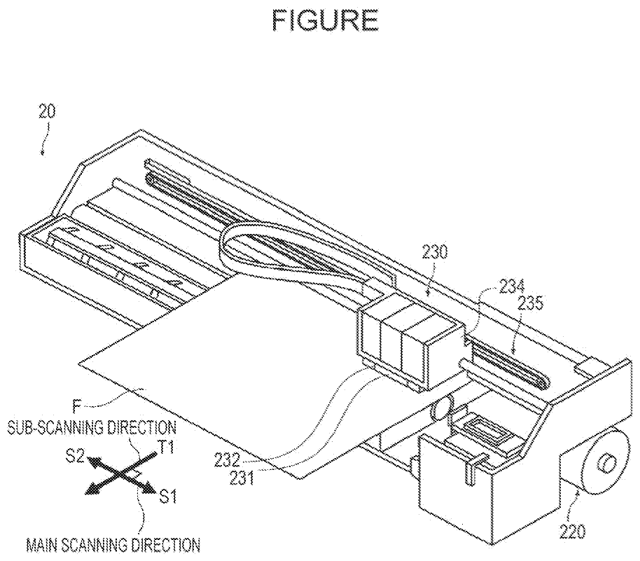

The present application is based on, and claims priority from JP Application Serial Number 2022-005600, filed Jan. 18, 2022, the disclosure of which is hereby incorporated by reference herein in its entirety.

### BACKGROUND

### 1. Technical Field

The present disclosure relates to a method for producing a printed material and a wrapping method with wrapping material.

### 2. Related Art

Ink jet printing methods, which enable high-definition image printing with a relatively simple apparatus, have been rapidly developed in various fields. In particular, such an ink jet method has been studied to be applied to printing on various wrapping materials. Shrink films are a type of film used as wrapping materials. However, when ink jet-printed shrink films are used as labels, the printed image of the label may be degraded due to the melting or discoloration of the ink resulting from the low heat resistance of the ink. Further, the reaction heat that arises from radiation curing may heat the shrink film to cause the shrink film to shrink nonuniformly at heat treatment for wrapping bottles.

JP-A-2003-285540 discloses a shrink film adapted for ink jet printing. The shrink film uses a resin with a specific glass transition temperature (Tg) and thermally shrinks to specific degrees each when heated in the hot air of 70° C. for 1 minute and when heated in the hot air of 70° C. for 1 minute and thereafter further heated in the hot air of 140° C. for 1 minute.

For wrapping PET bottles or other objects to be wrapped, a shrink film is typically thermally shrunk. Unfortunately, when the shrink film is thermally shrunk, the ink coating may wrinkle or cause other problems depending on the physical properties of the radiation-curable ink composition applied onto the shrink film.

### SUMMARY

Accordingly, the present disclosure provides a method for producing a printed material including an application step of applying a radiation-curable ink composition onto a shrink film, and a curing step of irradiating the radiation-curable ink composition on the shrink film with radiation to form a cured ink coating, thus obtaining a printed material. The radiation-curable ink composition contains one or more polymerizable compounds whose weighted average glass transition temperature is 20° C. to 70° C.

Also, a wrapping method with wrapping material is provided. The wrapping method includes a heating step of heating a printed material covering an object to be wrapped.

### BRIEF DESCRIPTION OF THE DRAWING

The FIGURE is a perspective view of a serial ink jet apparatus used in an embodiment of the present disclosure.

### DESCRIPTION OF EXEMPLARY EMBODIMENTS

Some embodiments of the present disclosure (hereinafter referred to as the “embodiments”) will now be described in detail with reference to the drawing as needed. However, the implementation of the concept of the disclosure is not limited to the embodiments disclosed herein, and various modifications may be made without departing from the scope and spirit of the disclosure. The same elements in the drawing are designated by the same reference numerals, and thus description thereof is omitted. The vertical, lateral, and other positional relationships are in accordance with the drawing unless otherwise specified. The dimensional proportions in the drawing are not limited to those illustrated in the drawing.

### 1. Method for Producing Printed Material

The method for producing a printed material according to an embodiment (hereinafter also referred to as the printed material production method) includes an application step of applying a radiation-curable ink composition onto a shrink film, and a curing step of irradiating the radiation-curable ink composition (hereinafter also referred to as the “ink composition”) on the shrink film with radiation to form a cured ink coating, thus obtaining a printed material. The radiation-curable ink composition contains one or more polymerizable compounds whose weighted average glass transition temperature is 20° C. to 70° C.

Printed materials obtained by applying an ink composition on a shrink film as a printing medium may have wrinkles on the printed side of the shrink film after being thermally shrunk because the coating of the ink composition cannot follow the thermal shrinkage of the shrink film. Many of the printed materials with ink compositions on a shrink film are rolled into a roll for storage. When the printed material is rolled, however, the printed side of the shrink film comes into contact with the other side, or the non-printed side, thus they are likely to stick to each other.

In contrast, the printed material production method according to the embodiment can reduce the likelihood that thermal shrinkage causes the shrink film to wrinkle on the ink coating and the likelihood that when the shrink film is rolled into a roll for storage, both sides of the film stick together in the roll, by controlling the weighted average glass transition temperature of the polymerizable compounds in the radiation-curable ink composition. In the following description, when wrinkles are less likely to be produced on the ink coating by thermal shrinkage, it is expressed that the printed material has high “shrink quality”, and when the printed side and the non-printed side are less likely to stick to each other, it is expressed that the printed material has good “blocking resistance”.

The steps of the printed material production method according to the embodiment will be described in detail, and then the radiation-curable ink composition will be described.

### 1. 1. Application Step

In the application step, the radiation-curable ink composition is applied onto a shrink film. For example, the ink composition may be applied by letterpress, intaglio printing, planography, or stencil printing, as well as an ink jet method. In some embodiments, the ink jet method of ejecting the radiation-curable ink composition from an ink jet head onto a shrink film is used. More specifically, the ink composition in a pressure generating chamber of the ink jet head is ejected through nozzles by the operation of a pressure-generating device. Such an ink jet method can facilitate the production of high-quality printed materials. In the following embodiment, the printed material production method according to the embodiment uses, but is not limited to, an ink jet method as an example.

In an ink jet method, an ink composition is ejected from an ink jet head onto a printing medium. More specifically, the ink composition in the pressure generating chamber of the ink jet head may be ejected through nozzles by the operation of a pressure-generating device.

The ink jet head used in the application step may be a line head used for line printing or a serial head used for serial printing.

For line printing with a line head, for example, an ink jet head with a width more than or equal to the print width of the printing medium is fixed to an ink jet apparatus. While the printing medium is moved in a sub-scanning direction (longitudinal direction of the printing medium, medium transport direction), ink droplets are ejected through the nozzles of the ink jet head in conjunction with the movement of the printing medium, thus printing an image on the printing medium.

For serial printing with a serial head, an ink jet head is mounted on or in a carriage capable of moving across the width of the printing medium. While the carriage is moved in a main scanning direction (lateral or width direction of the printing medium), the ink jet head ejects ink droplets through the nozzles, thus printing an image on the printing medium.

In the application step, the amount of the radiation-curable ink composition to be applied onto a shrink film may be such that the cured ink coating of the ink composition has a maximum thickness of 7.5 μm or less or 5 μm or less, for example, 1.0 μm to 5.0 μm. When the maximum thickness of the cured ink coating is 7.5 μm or less, the volume of the roll of the printed material rolled, for example, in a layering step described later, can be reduced to the extent equivalent to the decrease in the thickness of the ink coating, thereby increasing capacity for storage. Also, the concept of the present disclosure is particularly useful for the printed material having a cured ink coating with a maximum thickness of 1.0 μm or more, which is likely to produce wrinkles on the ink coating during thermal shrinkage.

The shrink film in the present embodiment refers to a film that is shrunk by 10% or more at least in one direction by heating to 80° C., and that may be shrunk by 15% or more, for example, by 20% or more or by 30% or more. A shrink film shrinkable to a higher degree is more likely to cause the ink coating to wrinkle when thermally shrunk. The concept of the present disclosure is useful for such shrink films.

The degree of shrinkage of a shrink film when heated to 80° C. can be determined as described below. The degree of shrinkage may be measured in any direction. In the present embodiment, the shrinkage in at least one of the directions providing the largest shrinkage is within the above range. When an oriented film whose resin is oriented in a direction by stretching an unstretched film in the orientation direction is heated, the stress caused by the molecular orientation is released, and the film shrinks to the dimension before stretching. The degree and the direction of shrinkage can be adjusted in the stretching step described later, and the direction of shrinkage may be, but is not limited to, either the machine direction or the width direction, or both.

Degree of shrinkage (%)=[(length before shrinkage)−(length after shrinkage)]/(length before shrinkage)

Examples of the resin that forms the shrink film include, but are not limited to, polyolefin resin, polyester resin, polystyrene resin, and polyvinyl chloride resin. For example, a shrink film may be formed of a polyester resin produced by condensation polymerization of a dicarboxylic acid component and a polyhydric alcohol component.

Examples of the dicarboxylic acid component include, but are not limited to, aromatic dicarboxylic acids and their salts, such as terephthalic acid, isophthalic acid, 1,4- or 2,6-naphthalenedicarboxylic acid, and sodium 5-sulfoisophthalate; dialkyl esters, diaryl esters, and other esterified derivatives of aromatic dicarboxylic acids; and aliphatic dicarboxylic acids, such as dimer acid, glutaric acid, adipic acid, sebacic acid, azelaic acid, oxalic acid, and succinic acid.

In addition to these, oxycarboxylic acids, such as p-oxybenzoic acid; and multivalent carboxylic acids, such as trimellitic anhydride and pyromellitic dianhydride may be used.

Examples of the polyhydric alcohol component include, but are not limited to, alkylene glycols, such as ethylene glycol, diethylene glycol, dimer diol, propylene glycol, triethylene glycol, 1,4-butanediol, neopentyl glycol, 1,3-cyclohexanedimethanol, 1,4-cyclohexanedimethanol, 1,6-hexanediol, 3-methyl-1,5-pentanediol, 2-methyl-1,5-pentanediol, 2,2-diethyl-1,3-propanediol, 1,9-nonanediol, and 1,10-decanediol; ethylene oxide adducts of bisphenol compounds or their derivatives; and trimethylolpropane, glycerin, pentaerythritol, polyoxytetramethylene glycol, and polyethylene glycol.

In addition to these, trimethylolethane, diglycerin, and other polyhydric alcohols may be used.

Examples of the polystyrene resin include, but are not limited to, polystyrene and poly(alkylstyrene), such as poly(p-, m-, or o-methylstyrene), poly(2,4-, 2,5-, 3,4- or 3,5-dimethylstyrene), and poly(p-tert-butylstyrene); poly(halogenated styrene), such as poly(p-, m-, or o-chlorostyrene), poly(p-, m-, or o-bromostyrene), poly(p-, m-, or o-fluorostyrene), and poly(o-methyl-p-fluorostyrene); poly(halogen-substituted alkylstyrene), such as poly(p-, m-, or o-chloromethylstyrene); poly(alkoxystyrene), such as poly(p-, m-, or o-methoxystyrene) and poly(p-, m-, or o-ethoxystyrene); poly(carboxyalkylstyrene), such as poly(p-, m-, or o-carboxymethylstyrene); poly(alkyl ether styrene), such as poly(p-vinylbenzyl propyl ether); poly(alkylsilylstyrene), such as poly(p-trimethylsilylstyrene); and poly(vinylbenzyldimethoxy phosphide).

The shrink film may contain a rubber component. Examples of the rubber component include, but are not particularly limited to, rubber produced by partially or fully hydrogenating the butadiene moieties of a styrene-butadiene block copolymer, styrene-butadiene copolymer rubber, styrene-isoprene block copolymers, rubber produced by partially or fully hydrogenating the butadiene moieties of a styrene-isoprene block copolymer, methyl acrylate-butadiene-styrene copolymer rubber, and methyl methacrylate-alkyl acrylate-butadiene-styrene copolymer rubber.

In some embodiments, the shrink film is an oriented film. The oriented film may be uniaxially oriented or biaxially oriented. The orientation may be performed in, but not limited to, a method including a stretching step of stretching unstretched film 2.0 to 8.0 times, for example, 2.5 to 6.0 times, at a temperature of (Tg−20°) C to (Tg+40°) C in a direction in which the resulting film is made shrinkable. Tg is the glass transition temperature of the resin forming the shrink film. After the stretching step, the film may be heat treated at a temperature of 50° C. to 110° C. while 0% to 15% stretched or relaxed.

### 1. 2. Curing Step

In the curing step, the radiation-curable ink composition on the shrink film is irradiated with radiation to form a cured ink coating, thus obtaining a printed material. On irradiating the ink composition with radiation, the polymerizable compounds start a polymerization reaction to cure the ink composition, thus forming an ink coating. At this time, a polymerization initiator, if present, produces an active species (initiation species), such as radicals, an acid, or a base. The initiation species promotes the polymerization reaction of the monomers. Additionally, a photosensitizer, if present, absorbs radiation and becomes excited. The excited photosensitizer comes into contact with the polymerization initiator to promote the decomposition of the polymerization initiator, thus promoting the curing reaction.

The radiation used herein may be ultraviolet light, infrared light, visible light, or X-rays. The radiation is applied to the ink composition from a radiation source disposed downstream of the ink jet head. The radiation source may be, but is not limited to, an ultraviolet light-emitting diode. The use of such a radiation source can reduce the size and cost of the apparatus. The ultraviolet light emitting diode used as the ultraviolet light source, which is small, can be incorporated into the ink jet apparatus.

For example, the ultraviolet light emitting diode may be attached to the carriage (on both ends of the carriage in the direction parallel to the width of the printing medium and/or on the medium transport direction side of the carriage) on or in which the ink jet head to eject the radiation-curable ink composition is mounted. Additionally, constituents and their proportions of the radiation-curable ink composition enable low-energy, rapid curing.

### 1. 3. Layering Step

The printed material production method according to the present embodiment may further include a layering step of layering the printed material such that one side of the printed material with the radiation-curable ink composition applied opposes the other side. The layering step may be performed by rolling a long printed material into a roll.

Typically, printed materials for industrial applications are rolled into rolls, and the rolls are stored with the ink-applied printed side and the other side pressed against each other inside the roll. This condition causes problems, particularly blocking. The concept of the present disclosure is particularly useful to such a case.

### 2. Wrapping Method With Wrapping Material

The wrapping method with wrapping material according to an embodiment includes a heating step of heating the printed material produced as described above with covering an object to be wrapped. Thus, the printed material covering the object to be wrapped is thermally shrunk to wrap the object.

At this time, the printed side may come into contact with the object to be wrapped, or the non-printed side may come into contact with the object.

The conditions of the heating step are not particularly limited, but the heating temperature may be 70° C. to 180° C., for example, 80° C. to 150° C. or 90° C. to 150° C. The heating time may be 3 seconds to 90 seconds, for example, 5 seconds to 60 seconds or 10 seconds to 30 seconds.

### 3. Radiation-Curable Ink Composition

The radiation-curable ink composition in the present embodiment is cured by irradiation with radiation. The radiation may be ultraviolet light, an electron beam, infrared light, visible light, or X-rays. In some embodiments, ultraviolet light is used as the radiation because of the prevalence and availability of the radiation source and the materials suitable for curing with UV light.

The radiation-curable ink composition in the present embodiment contains, but not limited to, one or more polymerizable compounds, a polymerization initiator, a polymerization inhibitor, a sensitizer, a surfactant, a coloring material, and a dispersant, for example. The ink composition does not necessarily contain all of these constituents and may contain some of them. The constituents of the radiation-curable ink composition in the present embodiment will now be described.

### 3. 1. Polymerizable Compound

In the present embodiment, compounds containing a polymerizable unsaturated bond are collectively referred to as polymerizable compounds. The polymerizable compounds contained in the ink composition may include one or more monofunctional monomers with one polymerizable functional group in the molecule and one or more multifunctional monomers with a plurality of polymerizable functional groups in the molecule. A polymerizable compound may be used independently, or two or more polymerizable compounds may be used in combination.

The weighted average glass transition temperature of the polymerizable compounds in the radiation-curable ink composition is 20° C. to 70° C. and, in some embodiments, may be 25° C. to 65° C., for example, 30° C. to 60° C. or 35° C. to 60° C. When the weighted average glass transition temperature is 20° C. or more, blocking resistance is improved. When the weighted average glass transition temperature is 20° C. or more, the ink composition also tends to exhibit improved curability. When the weighted average glass transition temperature is 70° C. or less, the shrink quality of the printed material is improved.

The glass transition temperature of a polymerizable compound refers to the glass transition temperature of the homopolymer of the polymerizable compound. The weighted average glass transition temperature of the polymerizable compounds can be controlled by the glass transition temperatures of the homopolymers of the polymerizable compounds to be used and their proportions by mass.

It will now be explained how to calculate the weighted average glass transition temperature of the homopolymers of polymerizable compounds. The weighted average glass transition temperature of the homopolymers is represented by T_{gA11}; the glass transition temperature of the homopolymers of polymerizable compounds is represented by Tg_{N}, and the proportion by mass of the polymerizable compound is represented by X_{N} (wt %). N is a variable from 1 to the number of polymerizable compounds in the radiation-curable ink composition, assigned in turn. For example, when three polymerizable compounds are used, the glass transition temperatures of their homopolymers are Tg₁, Tg₂, and Tg₃. The weighted average glass transition temperature Tg_{All} of homopolymers is the sum of the products of the glass transition temperature Tg_{N} of the homopolymer of each polymerizable compound and the proportion X_{N} by mass of the polymerizable compound. Thus, the following equation (1) holds.

Tg_{All}=ΣTg_{N}·X_{N} (1)

The glass transition temperature of the homopolymer of a polymerizable compound can be measured by differential scanning calorimetry (DSC) in accordance with JIS K 7121. More specifically, a sample prepared by polymerizing a monomer to the extent that its homopolymer exhibits a constant glass transition temperature is measured with a measurement apparatus, for example, Model DSC6220 manufactured by Seiko Instruments Inc.

The amount of the polymerizable compounds in the ink composition may be 55% to 85% by mass, for example, 60% to 80% by mass or 65% to 75% by mass, relative to the total mass of the ink composition. The ink composition containing such an amount of polymerizable compounds tends to improve blocking resistance and shrink quality and have improved curability.

### 3. 1. 1. Monofunctional Monomers

Examples of the monofunctional monomers include, but are not limited to, nitrogen-containing monofunctional monomers, aromatic group-containing monofunctional monomers, and alicyclic structure-containing monofunctional monomers. Optionally, one or more of such monofunctional monomers may be replaced with other monofunctional monomers, or the monofunctional monomers may include other monofunctional monomers.

The amount of the monofunctional monomers may be 50% by mass or more, for example, 60% to 95% by mass, 65% to 90% by mass, or 70% to 85% by mass, relative to the total mass of the polymerizable compounds. The use of one or more monofunctional monomers in a proportion of 50% by mass or more tends to improve the shrink quality of the printed material. Also, limiting the proportion of monofunctional monomers to 95% by mass or less tends to improve the blocking resistance of the printed material.

The following are examples of monofunctional monomers, but the monofunctional monomers used in the present embodiment are not limited to the following examples.

### 3. 1. 1. 1. Nitrogen-Containing Monofunctional Monomer

The polymerizable compounds may include a nitrogen-containing monofunctional monomer. The nitrogen-containing monofunctional monomer tends to increase the hardness of the obtained ink coating, resulting in improved blocking resistance.

Examples of the nitrogen-containing monofunctional monomer include, but are not limited to, nitrogen-containing monofunctional vinyl monomers, such as N-vinylcaprolactam (n-VC), N-vinylformamide, N-vinylcarbazole, N-vinylacetamide, vinyl methyl oxazolidinone (VMOX), and N-vinylpyrrolidone; nitrogen-containing monofunctional acrylate monomers, such as acryloylmorpholine (ACMO); and nitrogen-containing monofunctional (meth)acrylamide monomers, such as (meth)acrylamide, N-(hydroxymethyl) (meth)acrylamide, diacetone acrylamide, N,N-dimethyl (meth)acrylamide, and dimethylaminoethyl acrylate benzyl chloride quaternary salt.

In an embodiment, the ink composition may contain either a nitrogen-containing monofunctional vinyl monomer or a nitrogen-containing monofunctional acrylate monomer, particularly a monomer having a nitrogen-containing heterocyclic structure, such as vinyl methyl oxazolidinone, acryloylmorpholine, or N-vinylcaprolactam. In some embodiments, vinyl methyl oxazolidinone is used. Such a nitrogen-containing monofunctional monomer reduces the viscosity of the ink composition. Consequently, the ejection consistency of the ink composition tends to be improved. Also, the ink composition containing such a nitrogen-containing monofunctional monomer tends to improve the blocking resistance and shrink quality of the printed material and exhibit improved curability. Additionally, vinyl methyl oxazolidinone, which is a monomer with low viscosity at room temperature, tends to improve the ejection consistency of the ink composition.

The nitrogen-containing monofunctional monomer content may be 15% to 45% by mass, for example, 20% to 40% by mass or 25% to 35% by mass, relative to the total mass of the ink composition. The ink composition containing such an amount of nitrogen-containing monofunctional monomer tends to improve the blocking resistance and shrink quality of the printed material and exhibit improved curability.

### 3. 1. 1. 2. Aromatic Group-Containing Monofunctional Monomer

Examples of aromatic group-containing monofunctional monomers include, but are not limited to, phenoxyethyl (meth)acrylate, benzyl (meth)acrylate, alkoxylated 2-phenoxyethyl (meth)acrylate, ethoxylated nonylphenyl (meth)acrylate and other alkoxylated nonylphenyl (meth)acrylates, EO-modified p-cumylphenol (meth)acrylate, and 2-hydroxy-3-phenoxypropyl (meth)acrylate.

In an embodiment, phenoxyethyl (meth)acrylate or benzyl (meth)acrylate may be used. In some embodiments, phenoxyethyl (meth)acrylate, particularly phenoxyethyl acrylate (PEA), is used. Such an aromatic group-containing monofunctional monomer tends to increase the solubility of the polymerization initiator and improve the curability of the ink composition. In particular, the solubility of acylphosphine oxide-based polymerization initiators and thioxanthone-based polymerization initiators tends to be increased.

The aromatic group-containing monofunctional monomer content may be 25% to 55% by mass, for example, 30% to 50% by mass or 35% to 45% by mass, relative to the total mass of the ink composition. The ink composition containing such an amount of aromatic group-containing monofunctional monomer tends to improve the blocking resistance and shrink quality of the printed material and exhibit improved curability.

### 3. 1. 1. 3. Alicyclic Structure-Containing Monofunctional Monomer

Examples of alicyclic structure-containing monofunctional monomers include, but are not limited to, monocyclic hydrocarbon-containing monomers, such as tert-butylcyclohexanol (meth)acrylate (TBCHA), 3,3,5-trimethylcyclohexyl (meth)acrylate (TMCHA), and 1,4-dioxaspiro[4,5]dec-2-ylmethyl 2-(meth)acrylate; unsaturated polycyclic hydrocarbon-containing monomers, such as dicyclopentenyl (meth)acrylate and dicyclopentenyloxyethyl (meth)acrylate; and saturated polycyclic hydrocarbon-containing monomers, such as dicyclopentanyl (meth)acrylate and isobornyl (meth)acrylate (IBXA).

In some embodiments, isobornyl (meth)acrylate, tert-butylcyclohexanol acrylate, or trimethylcyclohexyl (meth)acrylate may be used, particularly isobornyl acrylate. The ink composition containing such an alicyclic structure-containing monofunctional monomer tends to improve the blocking resistance and shrink quality of the printed material and exhibit improved curability.

The alicyclic structure-containing monofunctional monomer content may be 15% to 45% by mass, for example, 20% to 40% by mass or 25% to 35% by mass, relative to the total mass of the ink composition. The ink composition containing such an amount of alicyclic structure-containing monofunctional monomer tends to improve the blocking resistance and shrink quality of the printed material and exhibit improved curability.

### 3. 1. 2. Multifunctional Monomers

Examples of the multifunctional monomers include, but are not limited to, vinyl group-containing (meth)acrylates and other multifunctional (meth)acrylates. Other multifunctional monomers may be used.

One or more multifunctional monomers may be used in a proportion of 5% to 40% by mass, for example, 10% to 30% by mass or 15% to 20% by mass, relative to the total mass of the polymerizable compounds. The use of one or more multifunctional monomers in a proportion of 5% by mass or more tends to improve the blocking resistance of the printed material. Also, limiting the proportion of multifunctional monomers to 40% by mass or less tends to improve the shrink quality of the printed material.

Examples of multifunctional monomers are given below, but the multifunctional monomers used in the embodiment are not limited to the following examples.

### 3. 1. 2. 1. Vinyl Group-Containing (Meth)Acrylate

Examples of vinyl group-containing (meth)acrylate include, but are not limited to, the compounds represented by formula (I) below:

H₂C═CR₁—CO—OR²—O—CH═CH—R³ (I)

wherein R¹ represents a hydrogen atom or a methyl group, R² represents a divalent organic residue with 2 to 20 carbon atoms, and R³ represents a hydrogen atom or a monovalent organic residue with 1 to 11 carbon atoms.

Such a vinyl group-containing (meth)acrylate tends to improve the blocking resistance and shrink quality of the printed material and the curability of the ink composition.

In formula (I), the divalent organic residue with 2 to 20 carbon atoms represented by R² may be a substituted or unsubstituted linear, branched, or cyclic alkylene group with 2 to 20 carbon atoms, a substituted or unsubstituted alkylene group with 2 to 20 carbon atoms having an oxygen atom of an ether bond and/or an ester bond in the molecular structure thereof, or a substituted or unsubstituted divalent aromatic group with 6 to 11 carbon atoms. In some embodiments, R² may be an alkylene group with 2 to 6 carbon atoms, such as ethylene, n-propylene, isopropylene, or butylene; or an alkylene group with 2 to 9 carbon atoms having an oxygen atom of an ether bond in the molecular structure, such as oxyethylene, oxy n-propylene, oxyisopropylene, or oxybutylene. In an embodiment, a compound having a glycol ether chain may be used, in which R² is an alkylene group with 2 to 9 carbon atoms having an oxygen atom of an ether bond in the molecular structure, such as oxyethylene, oxy n-propylene, oxyisopropylene, or oxybutylene from the viewpoint of reducing the viscosity of the ink composition and further improving the curability of the ink composition.

In formula (I) above, the monovalent organic residue with 1 to 11 carbon atoms represented by R³ may be a substituted or unsubstituted linear, branched, or cyclic alkyl group with 1 to 10 carbon atoms or a substituted or unsubstituted aromatic group with 6 to 11 carbon atoms. In some embodiments, R³ is an alkyl group with 1 or 2 carbon atoms, that is, methyl or ethyl, or an aromatic group with 6 to 8 carbon atoms, such as phenyl or benzyl.

When the organic residues are substituted, the substituent may or may not contain one or more carbon atoms. For the substituent containing one or more carbon atoms, the carbon atoms of the substituent are counted in the number of carbon atoms of the organic residue. Examples of the substituent containing one or more carbon atoms include, but are not limited to, carboxy and alkoxy. Examples of the substituent not containing carbon atoms include, but are not limited to, hydroxy and halogens.

Examples of the compound of formula (I) include, but are not limited to, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate. In some embodiments, 2-(2-vinyloxyethoxy)ethyl acrylate is used in view of the ease of balancing the curability and viscosity of the ink composition. In the embodiments described herein, 2-(2-vinyloxyethoxy)ethyl acrylate may be abbreviated to VEEA.

The vinyl group-containing (meth)acrylate content may be 1.0% to 10% by mass, for example, 2.0% to 8.0% by mass or 4.0% to 6.0% by mass, relative to the total mass of the ink composition. The ink composition containing such an amount of vinyl group-containing (meth)acrylate tends to improve the blocking resistance and shrink quality of the printed material and exhibit improved curability.

### 3. 1. 2. 2. Multifunctional (Meth)Acrylate

Examples of multifunctional (meth)acrylates include bifunctional (meth)acrylates, such as dipropylene glycol di(meth)acrylate, diethylene glycol di(meth)acrylate, triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A ethylene oxide (EO) adduct di(meth)acrylate, bisphenol A propylene oxide (PO) adduct di(meth)acrylate, hydroxypivalic acid neopentyl glycol di(meth)acrylate, and polytetramethylene glycol di(meth)acrylate; and trifunctional or more multifunctional (meth)acrylates, such as trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glyceryl propoxy tri(meth)acrylate, caprolactone-modified trimethylolpropane tri(meth)acrylate, pentaerythritolethoxy tetra(meth)acrylate, and caprolactam-modified dipentaerythritol hexa(meth)acrylate.

In some embodiments, dipropylene glycol diacrylate (DPGDA) is used. Such a multifunctional (meth)acrylate tends to improve the curability of the ink composition and the rub resistance of the ink coating and reduce the viscosity of the ink composition.

The multifunctional (meth)acrylate content may be 2.5% to 17.5% by mass, for example, 5.0% to 15% by mass or 7.5% to 12.5% by mass, relative to the total mass of the ink composition. The ink composition containing such an amount of multifunctional (meth)acrylate tends to exhibit improved curability and reduced viscosity.

### 3. 2. Polymerization Initiator

The polymerization initiator is a photopolymerization initiator that produces active species when irradiated with radiation. Examples of the polymerization initiator include, but are not limited to, acylphosphine oxide-based polymerization initiators, alkylphenone-based polymerization initiators, titanocene-based polymerization initiators, and thioxanthone-based polymerization initiators. In some embodiments, an acylphosphine oxide-based polymerization initiator or a thioxanthone-based polymerization initiator may be used, particularly an acylphosphine oxide-based polymerization initiator. Such a polymerization initiator tends to improve the curability of the ink composition. A polymerization initiator may be used independently, or two or more polymerization initiators may be used in combination.

The polymerization initiator content may be 2.5% to 17.5% by mass, for example, 5% to 15% by mass or 7.5% to 12.5% by mass, relative to the total mass of the ink composition. The ink composition containing such an amount of polymerization initiator tends to exhibit improved curability.

Examples of acylphosphine oxide-based polymerization initiators include, but are not limited to, 2,4,6-trimethylbenzoyldiphenylphosphine oxide, bis(2,4,6-trimethylbenzoyl)phenylphosphine oxide, and bis(2,6-dimethoxybenzoyl)-2,4,4-trimethylpentylphosphine oxide.

Commercially available acylphosphine oxide-based polymerization initiators include, but are not limited to, Omnirad 819 (bis(2,4,6-trimethylbenzoyl)-phenylphosphine oxide), IRGACURE 1800 (mixture of bis(2,6-dimethoxybenzoyl)-2,4,4-trimethylpentylphosphine oxide and 1-hydroxycyclohexyl phenyl ketone in a mass ratio of 25:75), and SpeedCure TPO (2,4,6-trimethylbenzoyldiphenylphosphine oxide), for example.

### 3. 3. Sensitizer

The sensitizer used in the ink composition may be, but is not limited to, a thioxanthone-based compound. Examples of the thioxanthone-based compound include, but are not limited to, thioxanthone, diethylthioxanthone, isopropylthioxanthone, and chlorothioxanthone.

Commercially available thioxanthone-based compounds include, but are not limited to, SpeedCure DETX (2,4-diethylthioxanthene-9-one) and SpeedCure ITX (2-isopropylthioxanthone), both produced by Lambson Group Ltd., and KAYACURE DETX-S (2,4-diethylthioxanthone) produced by Nippon Kayaku Co., Ltd.

The sensitizer content may be 0.5% to 7.5% by mass, for example, 1.5% to 5.0% by mass or 2.5% to 3.5% by mass, relative to the total mass of the ink composition. The ink composition containing such an amount of sensitizer tends to exhibit improved curability.

### 3. 4. Polymerization Inhibitor

Examples of polymerization inhibitors include, but are not limited to, p-methoxyphenol, hydroquinone monomethyl ether (MEHQ), 4-hydroxy-2,2,6,6-tetramethylpiperidine-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), 4,4′-thiobis(3-methyl-6-t-butylphenol), and hindered amine compounds, such as 2,2,6,6-tetramethylpiperidine-1-oxyl, 2,2,6,6-tetramethyl-4-hydroxypiperidine-1-oxyl (LA-7RD), and 2,2,6,6-tetramethylpiperidine-1-oxyl derivatives.

The polymerization inhibitor content may be 0.1% to 0.7% by mass, for example, 0.2% to 0.5% by mass, relative to the total mass of the ink composition. The ink composition containing such an amount of polymerization inhibitor tends to have improved storage stability.

### 3. 5. Surfactant

The surfactant may be, but is not limited to, an acetylene glycol-based surfactant, a fluorosurfactant, or a silicone surfactant.

Examples of the acetylene glycol-based surfactant include, but are not particularly limited to, 2,4,7,9-tetramethyl-5-decyne-4,7-diol and its alkylene oxide adducts; and 2,4-dimethyl-5-decyne-4-ol and its alkylene oxide adducts.

Examples of the fluorosurfactant include, but are not particularly limited to, perfluoroalkylsulfonic acid salts, perfluoroalkylcarboxylic acid salts, perfluoroalkylphosphoric acid esters, perfluoroalkylethylene oxide adducts, perfluoroalkylbetaines, and perfluoroalkylamine oxide compounds.

The silicone surfactant may be a polysiloxane compound or a polyester-modified or polyether-modified silicone. Examples of the polyester-modified silicone include BYK-347, BYK-348, BYK-UV 3500, BYK-UV 3510, and BYK-UV 3530 (all produced by BYK Additives & Instruments). The polyether-modified silicone may be BYK-3570 (produced by BYK Additives & Instruments).

The surfactant content may be 0.1% to 1.0% by mass, for example, 0.2% to 0.8% by mass, relative to the total mass of the ink composition. The ink composition containing such an amount of surfactant tends to have improved wettability.

### 3. 6. Coloring Material

The ink composition in the embodiment may further contain a coloring material. The ink composition in the embodiment containing a coloring material can be used as a colored ink composition. The coloring material may be at least either pigment or dye.

Inorganic pigments include carbon black (C.I. (Colour Index Generic Name) Pigment Black 7), such as furnace black, lamp black, acetylene black, and channel black; and iron oxide and titanium oxide.

Organic pigments include azo pigments, such as insoluble azo pigments, condensed azo pigments, azo lake, and chelate azo pigments; polycyclic pigments, such as phthalocyanine pigments, perylene and perinone pigments, anthraquinone pigments, quinacridone pigments, dioxane pigments, thioindigo pigments, isoindolinone pigments, and quinophthalone pigments; dye chelates, such as basic dye chelates and acid dye chelates; dye lakes, such as basic dye lakes and acid dye lakes; and nitro pigments, nitroso pigments, aniline black, and daylight fluorescent pigments.

The total coloring material content may be 0.5% to 15% by mass, for example, 1.0% to 10% by mass or 1.5% to 5.0% by mass, relative to the total mass of the ink composition but may be appropriately varied depending on the use of the ink composition. In an embodiment, the ink composition may be a clear ink containing no coloring material or a small amount (e.g., 0.1% by mass or less) of a coloring material to the extent that the coloring material is not intended for coloring.

Examples of the dye include, but are not limited to, acid dyes, such as C.I. Acid Yellows, C.I. Acid Reds, C.I. Acid Blues, C.I. Acid Oranges, C.I. Acid Violets, and C.I. Acid Blacks; basic dyes, such as C.I. Basic Yellows, C.I. Basic Reds, C.I. Basic Blues, C.I. Basic Oranges, C.I. Basic Violets, and C.I. Basic Blacks; direct dyes, such as C.I. Direct Yellows, C.I. Direct Reds, C.I. Direct Blues, C.I. Direct Oranges, C.I. Direct Violets, and C.I. Direct Blacks; reactive dyes, such as C.I. Reactive Yellows, C.I. Reactive Reds, C.I. Reactive Blues, C.I. Reactive Oranges, C.I. Reactive Violets, and C.I. Reactive Blacks; and disperse dyes, such as C.I. Disperse Yellows, C.I. Disperse Reds, C.I. Disperse Blues, C.I. Disperse Oranges, C.I. Disperse Violets, and C.I. Disperse Blacks. Such dyes may be used individually or in combination.

### 3. 7. Other Constituents

The radiation-curable ink composition in the embodiment may optionally contain additives such as a dispersant for the coloring material or the like.

### 4. Ink Jet Apparatus

The FIGURE is a perspective view of a serial printer as an example of the ink jet apparatus. As depicted in the FIGURE, the serial printer 20 includes a transport section 220 and a printing section 230. The transport section 220 transports a printing medium F fed to the serial printer to the printing section 230 and, after printing, ejects the printing medium outside the serial printer. More specifically, the transport section 220 includes feed rollers that transport the printing medium F fed thereto in a sub-scanning direction T1.

The printing section 230 includes an ink jet head 231 that ejects an ink composition onto the printing medium F fed from the transport section 220, a radiation source 232 that applies radiation to the ink composition on the printing medium, a carriage 234 holding the ink jet head 231 and the radiation source 232, and a carriage transfer mechanism 235 that transfers the carriage 234 in main scanning directions S1 and S2 in which the printing medium F is scanned.

In such a serial printer, the ink jet head 231 has a width smaller than the width of the printing medium and moves for a plurality of passes (multiple passes), thus performing printing. In the serial printer, the carriage 234, transferring in the predetermined directions, holds the ink jet head 231 and the radiation source 232, and the head ejects the ink composition onto the printing medium while being moved by the transfer of the carriage. Thus, printing is performed by two or more passes (multiple passes) of the head. A pass is also referred to as a main scan. Between two passes, a sub-scan is performed to transport the printing medium. Main scans and sub-scans are alternately performed.

In the embodiment illustrated in the FIGURE, the carriage holds the radiation source. However, another type of radiation source not held by the carriage may be used.

The ink jet apparatus in the embodiment is not limited to the serial printer and, in an embodiment, may be a line printer.

### Examples

The subject matter of the present disclosure will be further described in detail with reference to Examples and Comparative Examples. However, the implementation of the concept of the present disclosure is not limited to the following Examples.

### 1. Preparation of Ink Compositions

Constituents for each composition presented in the Table were placed into a mixing tank, followed by mixing and stirring, and the mixture was filtered through a membrane filter with a pore size of 5 μm. Thus, the ink compositions of the Examples were prepared. The values of the constituents in the Table are expressed by wt % unless otherwise specified.

TABLE

| | | | | | | | | | Comparative | |
|---|---|---|---|---|---|---|---|---|---|---|
| | Material | Tg | Molecular | Example | | | | | Example | |
| Material Type | name | [° C.] | weight | 1 | 2 | 3 | 4 | 5 | 1 | 2 |
| Monofunctional | VMOX | 120 | 127 | 30.0 | | | 20.0 | | 49.6 | 12.6 |
| monomer | ACMO | 145 | 141 | | 30.0 | | 15.0 | | | |
| | n-VC | 90 | 140 | | | 30.0 | | | | |
| | PEA | −22 | 192 | 40.0 | 40.0 | 40.0 | 35.0 | 40.0 | 15.0 | 60.0 |
| | IBXA | 94 | 208 | | | | | 30.0 | | |
| Multifunctional | VEEA | 39 | 186 | 4.6 | 4.6 | 4.6 | 4.6 | 4.6 | | |
| monomer | DPGDA | 104 | 242 | 10.0 | 10.0 | 10.0 | 10.0 | 10.0 | 20.0 | 12.0 |

| Polymerization | MEHQ | 0.2 | 0.2 | 0.2 | 0.2 | 0.2 | 0.2 | 0.2 |
|---|---|---|---|---|---|---|---|---|
| inhibiter | LA-7RD | 0.1 | 0.1 | 0.1 | 0.1 | 0.1 | 0.1 | 0.1 |
| Polymerization | Omnirad 819 | 5.0 | 5.0 | 5.0 | 5.0 | 5.0 | 5.0 | 5.0 |
| initiator | SpeedCureTPO | 4.8 | 4.8 | 4.8 | 4.8 | 4.8 | 4.8 | 4.8 |
| Sensitizer | SpeedCure DETX | 2.8 | 2.8 | 2.8 | 2.8 | 2.8 | 2.8 | 2.8 |
| Surfactant | BYK UV3500 | 0.5 | 0.5 | 0.5 | 0.5 | 0.5 | 0.5 | 0.5 |
| Dispersant | Solsperse36000 | 0.1 | 0.1 | 0.1 | 0.1 | 0.1 | 0.1 | 0.1 |
| Black pigment | Carbon black | 1.9 | 1.9 | 1.9 | 1.9 | 1.9 | 1.9 | 1.9 |
| Total | | 100.0 | 100.0 | 100.0 | 100.0 | 100.0 | 100.0 | 100.0 |
| Proportion (mass %) of monofunctional | | 70.0% | 70.0% | 70.0% | 70.0% | 70.0% | 64.0% | 72.6% |
| monomers to total mass of ink composition | | | | | | | | |
| Proportion (mass %) of monofunctional | | 82.7% | 82.7% | 82.7% | 82.7% | 82.7% | 76.4% | 85.8% |
| monomers to total mass of polymerizable | | | | | | | | |
| compounds | | | | | | | | |
| Proportion (mass %) of monofunctional | | 17.3% | 17.3% | 17.3% | 17.3% | 17.3% | 23.6% | 14.2% |
| monomers to total mass of polymerizable | | | | | | | | |
| compounds | | | | | | | | |
| Average Tg (° C.) of polymerizable | | 47 | 55 | 36 | 59 | 37 | 91 | 17 |
| compounds weighted by their proportions | | | | | | | | |
| by mass | | | | | | | | |
| Maximum thickness of cured coating [μm] | | 5 | 5 | 5 | 5 | 5 | 5 | 5 |
| Evaluation | Curability | A | B | B | A | C | A | C |
| | Blocking resistance | A | A | B | A | A | A | C |
| | Shrink quality | A | B | A | B | A | C | A |

The abbreviations and materials in the Table are as follows.

### PolyWerizable Compounds

Monofunctional Monomers

VMOX (vinyl methyl oxazolidinone, produced by BASF)

ACNO (acryloylmorpholine, produced by KJ Chemicals Corporation)

n-VC (N-vinylcaprolactau, available from ISP Japan)

PEA (phenoxyethyl acrylate, produced by Osaka Organic Chemical Industry Ltd.)

IBXA (isabornyl acrylate, produced by Osaka Organic Chemical Industry Ltd.)

Multifunctional Monomers

VERA (2-(2-vinyloxyethoxy)ethyl acrylate, produced by Nippon Shokubai Co., Ltd.)

DPGDA (dipropylene glycol diacrylate, produced by Sartomer)

### Polymerization Inhibitor

LA-7RD (product name of 2,2,6,6-tetramethyl-4-hydroxypiperidine-1-oxyl, produced by ADEKA Corporation)

MBHQ (hydroquinone monomethyl ether, available as p-Methoxyphenol (product name) produced by Kanto Chemical Co., Inc.)

### Polymerization Initiator

Omnirad 819 (bis (2,4,6-trimethylbenzoyl) phenylphosphine oxide, produced by IGM Resins)

SpeedCure TPO (2,4,6-trimethylbenzoyldiphenylphosphine oxide, produced by Lambson Group Ltd.)

### Sensitizer

Speedcure DBTX (2,4-diethylthioxanthen-9-one, produced by Lambson Group Ltd.)

### Surfactant

BYK-UV 3500 (silicone surfactant, produced by BYK Additives & Instruments)

### Dispersion Liquid

Dispersant: Bolsperse 36000 (polymer dispersant produced by Lubrizol Corporation)

Black pigment: carbon black

### 2. Evaluation

### 2. 1. Curability

Bach radiation-curable ink composition prepared above was applied onto a PET film with a bar coater to form an ink coating (that would be cured to have a thickness of 10 μm). The ink coating was irradiated with light from a UV light emitting diode (UV-LED, peak wavelength: 395 in, irradiation intensity: 60 sm/cm²), and the irradiation energy applied until the ink coating reached a tackiness-free condition was determined. The irradiation energy (m7/cm²) was obtained as the product of the irradiation intensity (mW/cm²) at the surface irradiated by the light source and the time duration (n) of irradiation.

Irradiation intensity was measured with a UV intensity meter UN-10 and a light receiver UM-400 (both produced by Konica Minolta Sensing, Inc.) Whether or not the ink coating reached a tackiness-free condition was determined according to whether or not the ink stuck to a cotton swab or whether or not the cured ink coating on the printing medium was scratched. For this test, Johnson swabs manufactured by Johnson & Johnson were used as the cotton swab. The cured ink coating was reciprocally rubbed ten times at a load of 100 g.

Curability was evaluated according to the following criteria based on the irradiation energy when the ink coating reached the tackiness-free condition.

### Criteria

A: Irradiation energy when reaching the tackiness-free condition: less than 150 mJ/cm²

B: Irradiation energy when reaching the tackiness-free condition: 150 mJ/cm² to less than 250 mJ/cm²

C: Irradiation energy when reaching the tackiness-free condition: 250 mJ/cm² or more

### 2. 2. Blocking

A solid pattern image was printed on a PET film “BoNsBT” (product name, manufactured by C.I. TAKIRON Corporation) as a printing medium under normal temperature and pressure using an ink jet printer “PX-G5000” (model name, manufactured by Seiko Epson Corporation) at a printing resolution of 600 dpi×600 dpi and a droplet weight of 20 ng (dot generation of 50%) to obtain a printed sample with a 5 μm-thick ink coating.

The solid pattern image is an image formed by filling all of the pixels, which are minimum printing unit regions defined by the printing resolution, with printed dots. While the solid pattern image was printed, UV light was applied from a UV-LBD mounted at the side of the carriage. Thus, a printed material with a 5 μm-thick cured coating of the ink composition on the printing medium was obtained.

The resulting printed material was rolled into a cylinder with the cured ink coating inside. The printed material was placed to surround a container (glass bottle) preheated as an object to be wrapped in a thermostatic chamber and allowed to stand for 10 seconds in the thermostatic chamber of 90° C. for shrinkage, thus adhering to the container.

The printed material that had been shrunk to adhere to the object for wrapping was checked for sticking by visually observing whether or not the cured ink Coating showed evidence of sticking (transfer) to the container, and thus blocking resistance was evaluated according to the following criteria.

### Criteria

A: No sticking of the cured ink coating to the container

B: slight sticking of the cured ink coating to the container

C: Firm sticking of the cured ink coating to the container (also peeling)

### 2. 2. Shrink Quality

The object wrapped in the blocking resistance test was checked for wrinkles by visual observation, and shrink quality was evaluated according to the following criteria.

### Criteria

A: The cured ink coating had no wrinkles.

B: The cured ink coating wrinkled slightly.

C: The cured ink coating wrinkled significantly.

What is claimed is:

1. A method for producing a printed material, comprising:
an application step of applying a radiation-curable ink composition onto a shrink film; and
a curing step of irradiating the radiation-curable ink composition on the shrink film with radiation to form a cured ink coating, thus obtaining a printed material, wherein
the radiation-curable ink composition contains one or more polymerizable compounds whose weighted average glass transition temperature is 20° C. to 70° C.

2. The method for producing the printed material according to claim 1, wherein
the polymerizable compounds include a nitrogen-containing monofunctional monomer.

3. The method for producing the printed material according to claim 2, wherein
the nitrogen-containing monofunctional monomer includes vinyl methyl oxazolidinone.

4. The method for producing the printed material according to claim 1, wherein
the polymerizable compounds include at least one monofunctional monomer in a proportion of 50% by mass or more relative to a total mass of the polymerizable compounds.

5. The method for producing the printed material according to claim 1, wherein
in the application step, the radiation-curable ink composition is applied onto the shrink film such that the cured ink coating has a thickness of at most 5 μm or less.

6. The method for producing the printed material according to claim 1, further comprising a layering step of layering the printed material such that one side of the printed material with the radiation-curable ink composition applied opposes an other side.

7. The method for producing the printed material according to claim 6, wherein
the layering step is performed by rolling the printed material into a roll.

8. The method for producing the printed material according to claim 1, wherein
in the application step, the radiation-curable ink composition is ejected from an ink jet head onto the shrink film.

9. A wrapping method with wrapping material, the method comprising:
a heating step of heating a printed material covering an object to be wrapped, the printed material being produced by the method as set forth in claim 1.
